(19) United States
(12) Patent Application Publication
(10) Pub. No.: US 2021/0205832 A1
(43) Pub. Date: Jul. 8, 2021

(54) System For Distributing Particulate Material With Section Delayed Control

(71) Applicant: CNH Industrial America LLC, New Holland, PA (US)

(72) Inventors: Rex Ruppert, Benson, MN (US); Lyle Mangen, Willmar, MN (US); Aaron Robert Tollefsrud, Willmar, MN (US); Sunil Vetal, Westmont, IL (US)

(21) Appl. No.: 16/736,282

(22) Filed: Jan. 7, 2020

(51) Int. Cl. B05B 12/12; B05B 1/20; A01C 15/00; A01C 21/00

(52) U.S. Cl. CPC B05B 12/126; A01C 21/00; A01C 15/003; B05B 1/20

(57) ABSTRACT

The invention provides a control system configured to start/stop metering of particulate material, upon command from a user, or according to a prescription map, with calculated sequencing and delays for starting/stopping boom sections, in order to achieve a substantially uniform distribution of material along a target line. In one aspect, following a command to stop metering, programming of when meters (corresponding to booms sections) turn off is updated to follow a delayed order according to multiple parameters, including ground speed of the machine, and flow of material, as determined by type of material, fan speed, tube diameter and tube length. The control system can dynamically account for such parameters to determine timing for when boom sections are selectively enabled/disabled to achieve the substantially uniform distribution.

### FIELD OF THE INVENTION

The present invention pertains to agricultural equipment and, more specifically, to a control system for distributing particulate material from an applicator in which detects a travel speed of the applicator, calculates a predetermined delay from the travel speed, controls an inner boom section to stop distribution of particulate material and after controlling the inner boom section to stop distribution, and after the delay, controls the outer boom section to stop distribution.

### BACKGROUND OF THE INVENTION

Agricultural product delivery systems are known to utilize various mechanisms, including mechanical and pneumatic systems to move granular or particulate material or product, such as fertilizer, seed, insecticide or herbicide, from a product supply chamber, through a series of elongated tubes that extend from a product supply chamber to a product applicator, and placing the product on, or in a growing medium, such as soil. Such agricultural product delivery systems are commonly employed in planters, air drills, fertilizer and pesticide applicators and a variety of other agricultural implements.

Systems as described typically include a switch in the cab which allows an operator to start/stop metering of particulate material. However, when metering is stopped, a given amount of time is still required for the material to distribute through the booms and onto the ground before the material is completely depleted. Nozzles on the booms that are closest to the machine or applicator will empty first, while nozzles on the booms that are furthest from the applicator will empty last. This typically results in an undesirable “V” pattern of product dispersed onto the ground when metering is stopped due to the continuous forward travel of the applicator. The rear boom can complicate this further by creating a flat spot in the middle of the “V.” A need therefore exists to provide a system for metering of particulate material that eliminates one or more of the foregoing disadvantages.

### SUMMARY OF THE INVENTION

The invention provides a control system configured to start/stop metering of particulate material, upon command from a user, or according to a prescription map, with calculated sequencing and delays for starting/stopping boom sections, in order to achieve a substantially uniform distribution of material along a target line. In one aspect, following a command to stop metering, programming of when meters (corresponding to booms sections) turn off is updated to follow a delayed order according to multiple parameters, including ground speed of the applicator, and flow of material, as determined by type of material, fan speed, tube diameter and tube length. The control system can dynamically account for such parameters to determine timing for when boom sections are selectively enabled/disabled to achieve the substantially uniform distribution.

In one aspect, to stop metering particulate material, longest boom sections of the applicator can turn off first, before a determined target line. Then, inner boom sections can turn off, closer to the target line. Finally, the rear boom section can turn off, approximately at the target line. Accordingly, metering of particulate material can be computer controlled to selectively delay shut-off meters on a per section basis to achieve a substantially straight line of dispersed product onto the ground with less overlap of material at ends of a field. To re-start metering particulate material, the boom sections can be reactivated in the reverse order.

Specifically then, one aspect of the present invention provides a control system for distributing particulate material from an applicator, the control system including: multiple supply lines, each supply line being configured to receive an airflow and entrain particulate material in the airflow; multiple boom sections, including an inner boom section and an outer boom section, each boom section being connected to a supply line for receiving an airflow and entrained particulate material, each boom section including multiple nozzles for distributing particulate material; and a control system configured to control distribution of particulate material through the boom sections, the control system executing a program stored in a non-transient medium operable to: receive a command to stop distribution of particulate material, following the command, detect a travel speed of the applicator; calculate a predetermined delay from the travel speed; control the outer boom section to stop distribution of particulate material; and after controlling the outer boom section to stop distribution of particulate material, and after the predetermined delay, control the inner boom section to stop distribution of particulate material.

Another aspect of the present invention provides a method for distributing particulate material from an applicator, the method including: providing multiple supply lines, each supply line for receiving an airflow and entraining particulate material in the airflow; providing multiple boom sections, including an inner boom section and an outer boom section, each boom section being connected to a supply line for receiving an airflow and entrained particulate material, each boom section including multiple nozzles for distributing particulate material; receiving a command to stop distribution of particulate material; detecting a travel speed of the applicator; following the command, calculating a predetermined delay from the travel speed; controlling the outer boom section to stop distribution of particulate material; and after controlling the outer boom section to stop distribution of particulate material, and after the predetermined delay, controlling the inner boom section to stop distribution of particulate material.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates an isometric view of an exemplary embodiment of an agricultural application implement in the form of a dry granular applicator, comprising a control system in accordance with an aspect of the present invention;

FIG. 2 illustrates a side elevation view of the applicator of FIG. 1, in accordance with an aspect of the present invention;

FIG. 3 illustrates a pneumatic conveying system of the applicator of FIG. 1 for distributing particulate material through boom sections in accordance with an aspect of the present invention;

FIG. 4 illustrates a diagram of a control system of the applicator of FIG. 1 for starting/stopping boom sections in accordance with an aspect of the present invention; and

FIG. 5 illustrates a process for stopping boom sections to achieve a substantially uniform distribution of particulate material in accordance with an aspect of the present invention.

While the invention is described herein in connection with certain preferred embodiments, there is no intent to limit it to those embodiments. On the contrary, the intent is to cover all alternatives, modifications and equivalents within the spirit and scope of the invention as defined by the appended claims.

### DETAILED DESCRIPTION OF THE INVENTION

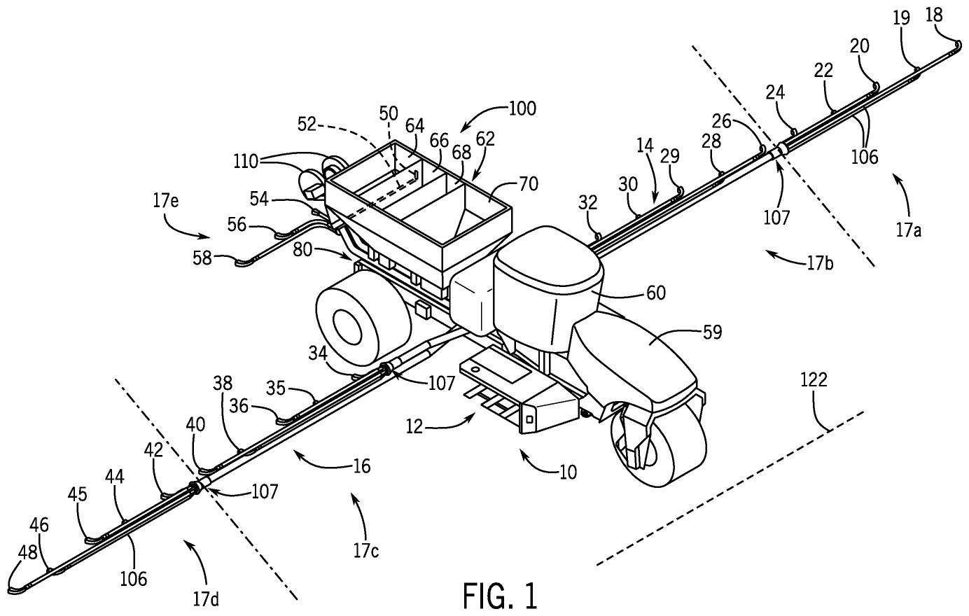

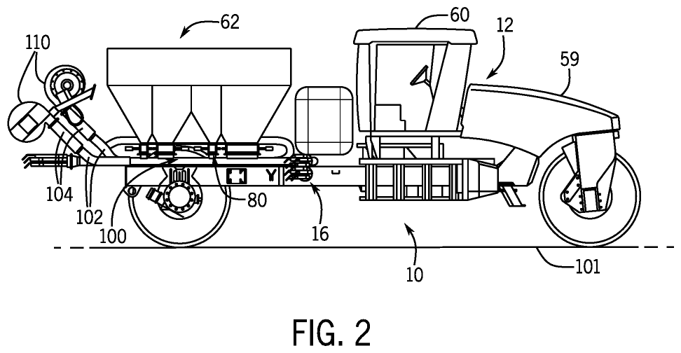

Referring now to the drawings, and more particularly to FIGS. 1 and 2, there is shown an agricultural application implement 10, which could be a dry pneumatic granular applicator. As is known in the art, implement 10 generally includes a large wheeled transport unit 12 such as truck or tractor, and laterally extending particle delivery booms 14 and 16, which may be pivoted to a stowed position close to the implement for storage or transport. Each boom 14, 16 extends laterally from the implement 10 in opposite directions. Each boom 14, 16 includes a plurality of boom sections 17, such as left outer and left inner boom sections 17a, 17b of boom 14, and right inner and right outer boom sections 17c, 17d of boom 16. Each boom section 17 is defined by a large diameter supply line 102 for supplying the boom section with granular or particulate material, such as seed, fertilizer, herbicide, insecticide and the like. Each boom section 17 includes a plurality of boom tubes or conduits terminating at particle delivering units, which for the implement 10 are spreading outlets or nozzles. In the exemplary embodiment shown, left outer boom section 17a of boom 14 includes five nozzles 18, 19, 20, 22 and 24; left inner boom section 17b of boom 14 includes five nozzles 26, 28, 29, 30 and 32; right inner boom section 17c of boom 16 includes five nozzles 34, 35, 36, 38 and 40; and right outer boom section 17d of boom 16 includes five nozzles 42, 44, 45, 46 and 48. Additionally, at the back of implement 10 there is a centrally mounted rear boom section 17e also defined by a large diameter supply line 102 for supplying the boom section with granular material. At the rear boom section 17e are five rear nozzles 50, 52, 54, 56 and 58 to provide full and complete coverage across the width of implement 10, including the area between the inboard-most nozzles 32 and 34 of booms 14, 16. The rear boom section 17e allows spread of the particulate material/product over/onto the ground over which the implement 10 passes for complete coverage. Although five boom sections 17, with five nozzles per boom section, is shown by way of example, in other aspects greater or fewer boom sections 17, and/or greater or fewer nozzles per boom section 17, can be provided within the scope of the invention.

The transport unit 12 can be self-propelled by an engine in an engine compartment 59 and can include an operator cab 60 having a Human Machine Interface (HMI) available to the user. In the exemplary embodiment shown, an uncovered tank 62 includes compartments 66 and 70 for carrying particulate material to be distributed in a metering section 80 for ultimate disbursement by nozzles 18-58. Further smaller compartments 64 and 68 are provided to supply micro-nutrients or other materials in the metering section 80. The supply of particulate in compartments 64, 66, 68, 70 can be replenished periodically from a supply vehicle (not shown).

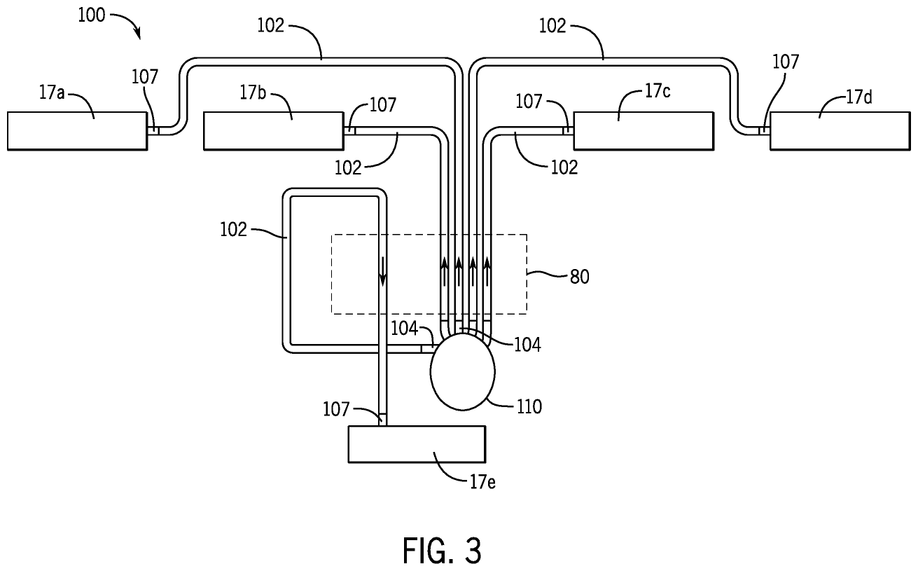

As shown in FIGS. 1-3 by way of example, the compartments 64-70 of the tank 62 and the metering section 80 are disposed directly above a conveying system 100, which could be a pneumatic conveying system or assembly. The conveying system 100 includes multiple large diameter supply lines 102, which could be 5 inches in diameter, that extend from a plenum 104 at one end, under the compartments 64-70 and terminate at individual boom sections 17. At each boom section 17, the supply lines 102 and the particulate material or product transported therein are split by a suitable distribution structure or mechanism 107, such as a plurality of horizontal rotary distributors, among or into a number of secondary or smaller supply lines 106, which could be 2.5 inches in diameter, that are connected to individual nozzles 18-58.

To collect and drive the particulate material along the lines 102, one or more fans 110 can be operably connected to the plenum 104 opposite the inlet ends of lines 102 as described herein. The air flow from the fans 110 is directed from through the plenum 104 and into the respective lines 102 as a result of the structure of the plenum 104. After the air flow passes through the plenum 104 and collects/entrains the particulate material from the compartments 64-70 via the metering section 80, the air flow continues to flow along each large diameter supply line 102, including with one or more 90° and/or 180° turns, to connect to the various boom sections 17. The fans 110 could be centrifugal tans that are 8 inches or less in diameter, and in some aspects, 6 inches or less.

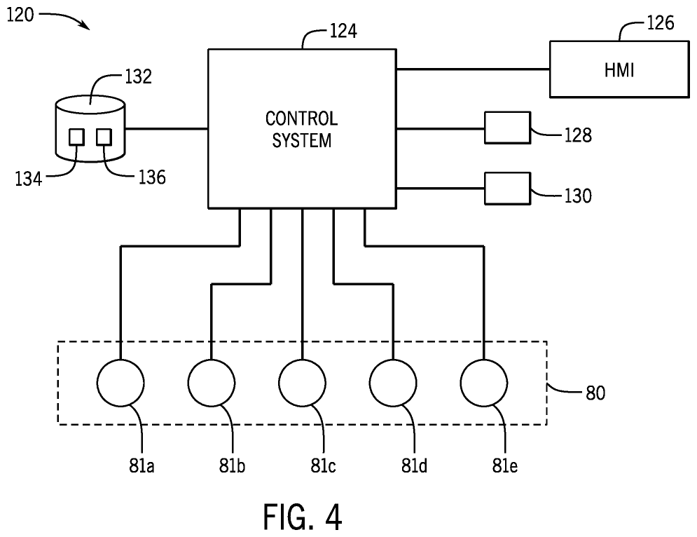

Referring now to FIG. 4, a diagram of a distribution system 120 of the implement 10 for starting; stopping sections 17 to achieve a substantially uniform distribution of material along a calculated target line 122 (see FIG. 1) is provided in accordance with an aspect of the present invention. The distribution system 120 can include a control system 124, such as a microcontroller or other programmable logic, in communication with the metering section 80, a Human Machine Interface (HMI) 126 provided in the cab 60, a speed sensor 128, one or more flow sensors 130 and a non-transient medium 132. The control system 124 can execute a program 134 stored in the non-transient medium 132 for distributing the particulate material, such as by selectively controlling meter rollers 81a-81e, of the metering section 80, corresponding to individual supply lines 102 leading to sections 17a-17e.

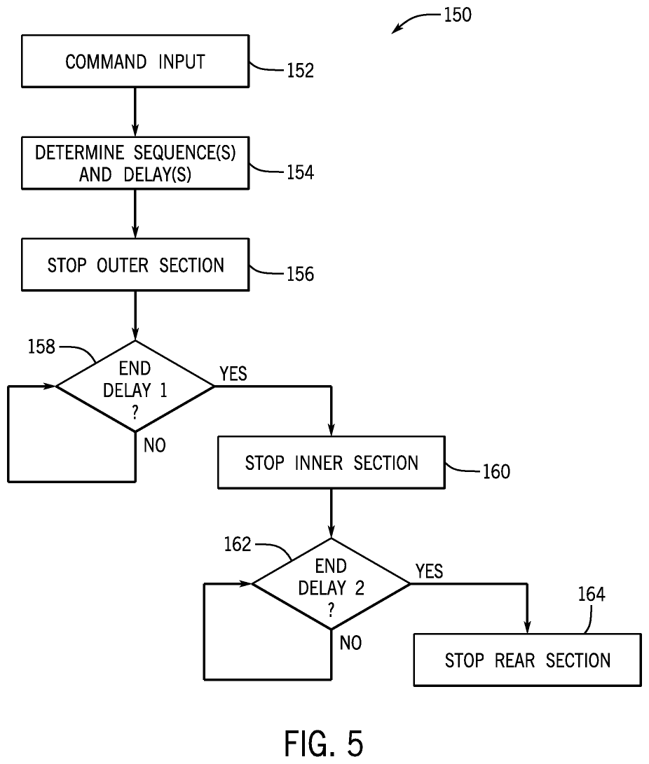

With additional reference to FIG. 5 and process 150, in one aspect, for stopping boom sections 17 to achieve a substantially uniform distribution of particulate material, at step 152, the control system 124 can execute to receive a command to stop distribution of particulate material. The command could be received via the HMI 126 according to a selection by a user in the cab 60. Alternatively, the command could be received according to execution of a prescription map.

Following the command, at step 154, the control system 124 can execute to determine sequence(s) and/or delay(s) for stopping each section 17. In one aspect, the control system can first detect a travel speed of the implement 10, such as via the speed sensor 128. The control system 124 can then calculate one or more predetermined delays for stopping particular sections 17, relative to the target line 122, based on the travel speed and based on the flow of particulate material though the supply lines 102. The flow of particulate material can be determined, for example, using the one or more flow sensors 130 configured to detect fan speed and/or airflow in the supply lines 102 indicating a speed of the material, by referencing the HMI 126 indicating the type of particulate material selected for distribution, and/or by referencing a data structure 136 stored in the non-transient medium 132 indicating a configuration of the sections 17, including supply line tube diameter(s), length(s) and/or routing. For a configuration of the implement 10, having boom sections 17a-17e, the control system can determine a first predetermined delay for stopping inner boom sections 17b, 17c after having stopped outer boom sections 17a, 17d, and a second predetermined delay for stopping rear boom section 17e after having stopped inner boom sections 17b, 17c.

Next, at step 156, the control system 124 can control outer boom sections 17a, 17d to stop distribution of particulate material. Then, after controlling the outer boom sections to stop distribution, the process can proceed to decision step 158 to execute the first predetermined delay according to the aforementioned travel speed and flow. After the first predetermined delay expires (“Yes”), at step 160, the control system 124 can control the left and right inner boom sections 17b, 17c to stop distribution of particulate material. Then, after controlling the inner boom sections to stop distribution, the process can proceed to decision step 162 to execute the second predetermined delay according to the aforementioned travel speed and flow. After the second predetermined delay expires (“Yes”), at step 164, the control system 124 can control the rear boom section 17e to stop distribution of particulate material. Accordingly, the control system 124 dynamically accounts for various parameters of travel speed and flow to determine timing for when boom sections 17 are selectively disabled to achieve the substantially uniform distribution at the target line 122. To start (or re-start) metering particulate material, the boom sections 17 can be activated (or reactivated) in the reverse order of the process 150.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

What is claimed is:

1. A control system for distributing particulate material from an applicator, the control system comprising:
a plurality of supply lines, each supply line being configured to receive an airflow and entrain particulate material in the airflow;
a plurality of boom sections, including an inner boom section and an outer boom section, each boom section being connected to a supply line for receiving an airflow and entrained particulate material, each boom section comprising a plurality of nozzles for distributing particulate material; and
a control system configured to control distribution of particulate material through the plurality of boom sections, the control system executing a program stored in a non-transient medium operable to:
receive a command to stop distribution of particulate material;
following the command, detect a travel speed of the applicator;
calculate a predetermined delay from the travel speed;
control the outer boom section to stop distribution of particulate material; and
after controlling the outer boom section to stop distribution of particulate material, and after the predetermined delay, control the inner boom section to stop distribution of particulate material.

2. The control system of claim 1, wherein the inner boom section and the outer boom section are a left inner boom section and a left outer boom section, respectively, and further comprising a right inner boom section and a right outer boom section, wherein the left and right inner boom sections are controlled to stop distribution together, and wherein the left and right outer boom sections are controlled to stop distribution together.

3. The control system of claim 1, wherein the plurality of boom sections further includes a rear boom section that is centered relative to the applicator.

4. The control system of claim 3, wherein the predetermined delay is a first predetermined delay, and wherein the control system is further operable to calculate a second predetermined delay from the travel speed and, after controlling the inner boom section to stop distribution of particulate material, and after the second predetermined delay, control the rear boom section to stop distribution of particulate material.

5. The control system of claim 1, further comprising a metering section for distributing particulate material to the plurality of supply lines, wherein the control system controls distribution of particulate material by controlling the metering section.

6. The control system of claim 1, further comprising a Human Machine Interface (HMI) provided in a cab of the applicator, wherein the control system is configured to receive the command from the HMI.

7. The control system of claim 1, wherein the control system is configured to receive the command according to a prescription map.

8. The control system of claim 1, wherein the control system is further operable to calculate the predetermined delay according to a type of particulate material selected for distribution.

9. The control system of claim 1, wherein the control system is further operable to calculate the predetermined delay according to a speed of particulate material in the plurality of supply lines.

10. The control system of claim 1, wherein the control system is further operable to calculate the predetermined delay according to a length of each supply line.

11. The control system of claim 1, wherein the control system is further operable to calculate the predetermined delay according to a diameter of each supply line.

12. A method for distributing particulate material from an applicator, the method comprising:
providing a plurality of supply lines, each supply line for receiving an airflow and entraining particulate material in the airflow;
providing a plurality of boom sections, including an inner boom section and an outer boom section, each boom section being connected to a supply line for receiving an airflow and entrained particulate material, each boom section comprising a plurality of nozzles for distributing particulate material;
receiving a command to stop distribution of particulate material;
following the command, detecting a travel speed of the applicator;
calculating a predetermined delay from the travel speed;
controlling the outer boom section to stop distribution of particulate material; and
after controlling the outer boom section to stop distribution of particulate material, and after the predetermined delay, controlling the inner boom section to stop distribution of particulate material.

13. The method of claim 12, wherein the inner boom section and the outer boom section are a left inner boom section and a left outer boom section, respectively, and further comprising providing a right inner boom section and a right outer boom section, controlling the left and right inner boom sections to stop distribution together, and controlling the left and right outer boom sections to stop distribution together.

14. The method of claim 12, wherein the plurality of boom sections further includes a rear boom section that is centered relative to the applicator.

15. The method of claim 14, wherein the predetermined delay is a first predetermined delay, and further comprising calculating a second predetermined delay from the travel speed and, after controlling the inner boom section to stop distribution of particulate material, and after the second predetermined delay, controlling the rear boom section to stop distribution of particulate material.

16. An agricultural application implement comprising:
a plurality of wheels supporting a frame supporting:
a plurality of supply lines, each supply line being configured to receive an airflow and entrain particulate material in the airflow;
a plurality of boom sections, including an inner boom section and an outer boom section, each boom section being connected to a supply line for receiving an airflow and entrained particulate material, each boom section comprising a plurality of nozzles for distributing particulate material; and
a control system configured to control distribution of particulate material through the plurality of boom sections, the control system executing a program stored in a non-transient medium operable to:
receive a command to stop distribution of particulate material;
following the command, detect a travel speed of the applicator;
calculate a predetermined delay from the travel speed;
control the outer boom section to stop distribution of particulate material; and
after controlling the outer boom section to stop distribution of particulate material, and after the predetermined delay, control the inner boom section to stop distribution of particulate material.
